(19) United States
(12) Patent Application Publication
(10) Pub. No.: US 2015/0103261 A1
(43) Pub. Date: Apr. 16, 2015

(54) TOUCH PANEL AND MANUFACTURING METHOD THEREOF

(71) Applicant: SAMSUNG ELECTRO-MECHANICS CO., LTD., Suwon (KR)

(72) Inventors: Seung Min LEE, Suwon (KR); Sung Han, Suwon (KR); Hyun Dong Lee, Suwon (KR)

(21) Appl. No.: 14/103,159

(22) Filed: Dec. 11, 2013

(30) Foreign Application Priority Data
Oct. 15, 2013 (KR) 10-2013-0122773

(51) Int. Cl. G06F 1/16; C23F 4/04

(52) U.S. Cl. CPC G06F 1/1643; C23F 4/04
USPC 349/12; 216/13

(57) ABSTRACT

There are provided a touch panel and a manufacturing method thereof, the touch panel including: a substrate, a plurality of fine conductive lines provided on one surface of the substrate, and a black treated part including a first black layer and a second black layer provided on the one surface of the substrate, wherein the first black layer, the plurality of fine conductive lines, and the second black layer are sequentially stacked on the substrate, the first black layer has a width wider than a line width of the fine conductive lines, and the second black layer has a width narrower than the line width of the fine conductive lines.

### CROSS-REFERENCE TO RELATED APPLICATIONS

This application claims the benefit of Korean Patent Application No. 10-2013-0122773 filed on Oct. 15, 2013, with the Korean Intellectual Property Office, the disclosure of which is incorporated herein by reference.

### BACKGROUND

The present disclosure relates to a touch panel and a manufacturing method thereof.

In recent times, a touch sensing apparatus such as a touchscreen, a touchpad, or the like, a data input apparatus attached to a display apparatus to provide an intuitive data input method to a user, has been widely used in various electronic devices such as cellular phones, personal digital assistants (PDA), navigation devices, and the like. Particularly, as demand for smartphones has recently increased, the use of a touchscreen capable of providing various data input methods in a limited form factor has increased.

Touchscreens used in portable devices may be mainly divided into resistive type touchscreens and capacitive type touchscreens, according to a method of sensing a touch. Here, the capacitive type touchscreen has advantages in that it has a relatively long lifespan and various data input methods and gestures may easily implemented for use therewith, such that the use thereof has increased. Particularly, the capacitive type touchscreen may easily implement a multi-touch interface as compared with the resistive type touchscreen, such that it is widely used in devices such as smartphones, and the like.

The capacitive type touchscreen includes a plurality of electrodes having a predetermined pattern and defining a plurality of nodes in which changes in capacitance are generated by a touch. In the plurality of nodes distributed on a two-dimensional plane, a change in self-capacitance or in mutual-capacitance is generated by a touch. Coordinates of the touch may be calculated by applying a weighted average method, or the like, to the changes in capacitance generated in the plurality of nodes.

In a touch panel according to the related art, a sensing electrode recognizing a touch is generally formed of indium tin oxide (ITO). However, ITO is relatively expensive and has low price competitiveness, since indium, used as a raw material thereof, is a rare earth metal. In addition, indium reserves are expected to be depleted within the next decade, such that an uninterrupted supply thereof may not be assured. Research into technology for forming electrodes using non-transparent fine conductive lines has been undertaken for the reasons mentioned above. Here, an electrode formed of fine conductive lines formed of such a metal may have more excellent conductivity than that of an electrode formed of ITO or a conductive polymer and may allow a current to be smoothly supplied. However, in the case in which the fine conductive lines are used as the electrode for the touchscreen, a user may be able to visually distinguish the fine conductive lines due to color and light reflection of the metal which are generated thereby.

### RELATED ART DOCUMENT

(Patent Document 1) Korean Patent Laid-Open Publication No. 10-2011-0089423

### SUMMARY

An aspect of the present disclosure may provide a touch panel having improved visibility by forming at least one black layer having a width different from a line width of a fine conductive line on an upper surface and a lower surface of the fine conductive line, and a manufacturing method thereof.

According to an aspect of the present disclosure, a touch panel may include: a substrate; a plurality of fine conductive lines provided on one surface of the substrate; and a black treated part including a first black layer and a second black layer provided on the one surface of the substrate, wherein the first black layer, the plurality of fine conductive lines, and the second black layer are sequentially stacked on the substrate, the first black layer has a width wider than a line width of the fine conductive lines, and the second black layer has a width narrower than the line width of the fine conductive lines.

The fine conductive lines may have an etching rate higher than that of the first black layer and lower than that of the second black layer.

The width of the second black may correspond to ⅓ of the line width of the fine conductive lines.

The first black layer and the second black layer may have complementary colors to each other.

The plurality of fine conductive lines may be formed of one of Ag, Al, Cr, Ni, Mo, and Cu, or an alloy of at least two of Ag, Al, Cr, Ni, Mo, and Cu.

The touch panel may further include a cover window adhered to the one surface of the substrate.

According to another aspect of the present disclosure, a manufacturing method of a touch panel may include: stacking three metal layers on one surface of a substrate; and forming an electrode pattern by etching the three metal layers using a single etchant, wherein the three metal layers have an etching rate that increases as a height of the stacked metal layers are increased.

The forming of the electrode pattern may include: coating a photo-resist on a highest layer of the three metal layers; forming a predetermined mask pattern by exposing and developing the photo-resist; and forming a first black layer, fine conductive lines, and a second black layer, sequentially stacked on the substrate, by etching the three metal layers along the mask pattern.

The first black layer may have a width wider than a line width of the fine conductive lines, and the second black layer may have a width narrower than the line width of the fine conductive lines.

The width of the second black layer may correspond to ⅓ of the line width of the fine conductive lines.

A metal material of a highest metal layer and a metal material of a lowest metal layer, among the three metal layers, may have complementary colors to each other.

The method may further include: bonding a cover window to the one surface of the substrate by a predetermined adhesive layer.

An intermediate layer of the three metal layers may be formed of one of Ag, Al, Cr, Ni, Mo, and Cu, or an alloy of at least two of Ag, Al, Cr, Ni, Mo, and Cu.

According to another aspect of the present disclosure, a touch panel may include: a substrate; a plurality of fine conductive lines provided on one surface of the substrate; and a black treated part including a first black layer formed on one surface of the fine conductive lines, facing the substrate, and a second black layer formed on the other surface of the fine conductive lines, opposite to one surface of the fine conductive lines; wherein the first black layer has a width wider than a line width of the fine conductive lines, and the second black layer has a width narrower than the line width of the fine conductive lines.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view showing the exterior of an electronic device including a touch panel according to an exemplary embodiment of the present disclosure;

FIG. 2 is a front view of the touch panel according to an exemplary embodiment of the present disclosure; and

FIGS. 3 and 4 are cross-sectional views of the touch panel according to various exemplary embodiments of the present disclosure.

### DETAILED DESCRIPTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

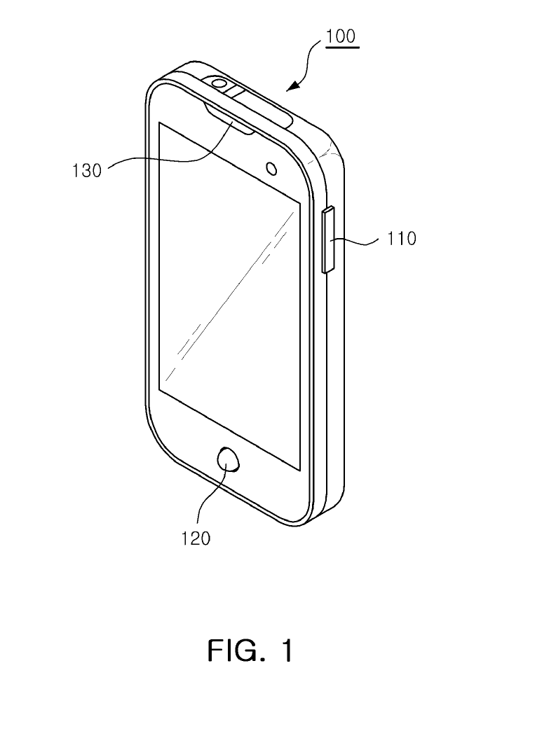

FIG. 1 is a perspective view showing the exterior of an electronic device including a touch panel according to an exemplary embodiment of the present disclosure.

Referring to FIG. 1, an electronic device 100 according to the present exemplary embodiment may include a display apparatus 110 for outputting an image, an input unit 120, an audio unit 130 for outputting audio, and a touchscreen apparatus integrated with the display apparatus 110, and a touch panel may be included in the touchscreen apparatus.

As shown in FIG. 1, in a case of a mobile device, the touchscreen apparatus may be generally integrated with the display apparatus and needs to have a high degree of light transmissivity enough to transmit an image displayed by the display apparatus. Therefore, the touchscreen apparatus may be implemented by forming an electrode on a film such as polyethylene terephtalate (PET), polycarbonate (PC), polyethersulfone (PES), polyimide (PI), polymethlymethacrylate (PMMA), cyclo-olefin polymers(COP), or the like, and a transparent substrate formed of a material such as soda glass or tempered glass using a material having conductivity. The display apparatus may include a wiring pattern disposed in a bezel region thereof, and the wiring pattern is connected to the electrode formed of the transparent and conductive material, and is visually shielded by the bezel region.

The touchscreen apparatus may be a capacitive type touchscreen apparatus and accordingly, it may include a plurality of electrodes having a predetermined pattern. Also, the touchscreen apparatus according to an embodiment of the present disclosure may include a capacitance detection circuit detecting changes in capacitance generated in the plurality of electrodes, an analog-to-digital conversion circuit converting an output signal from the capacitance detection circuit into a digital value, an operation circuit determining a touch input by using data converted as the digital value, and the like.

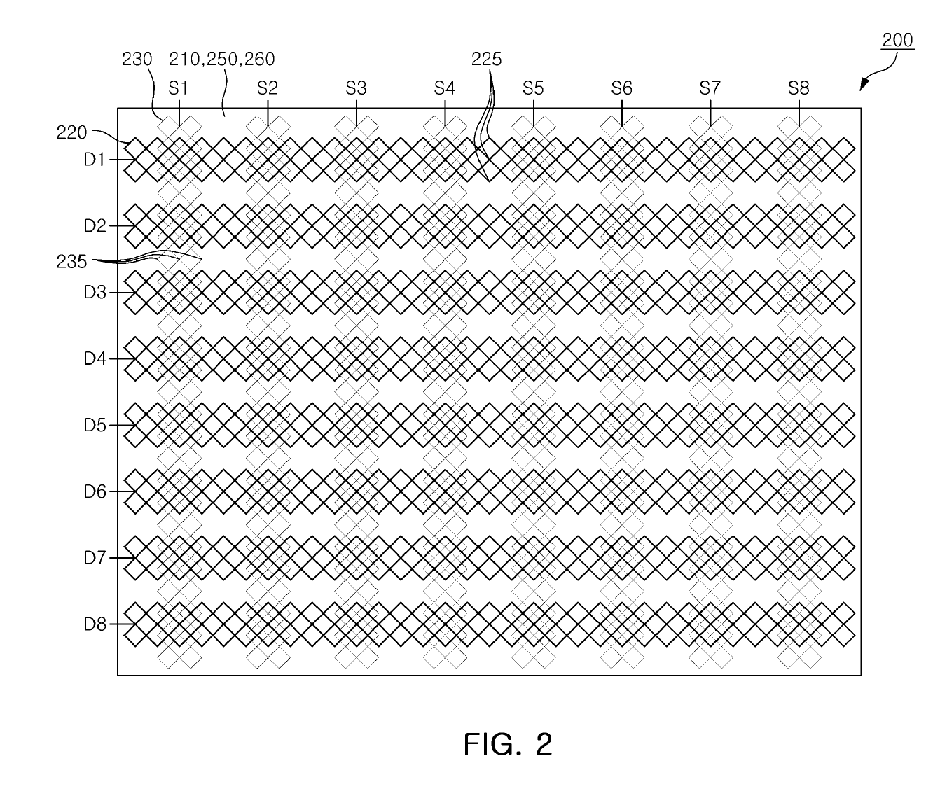

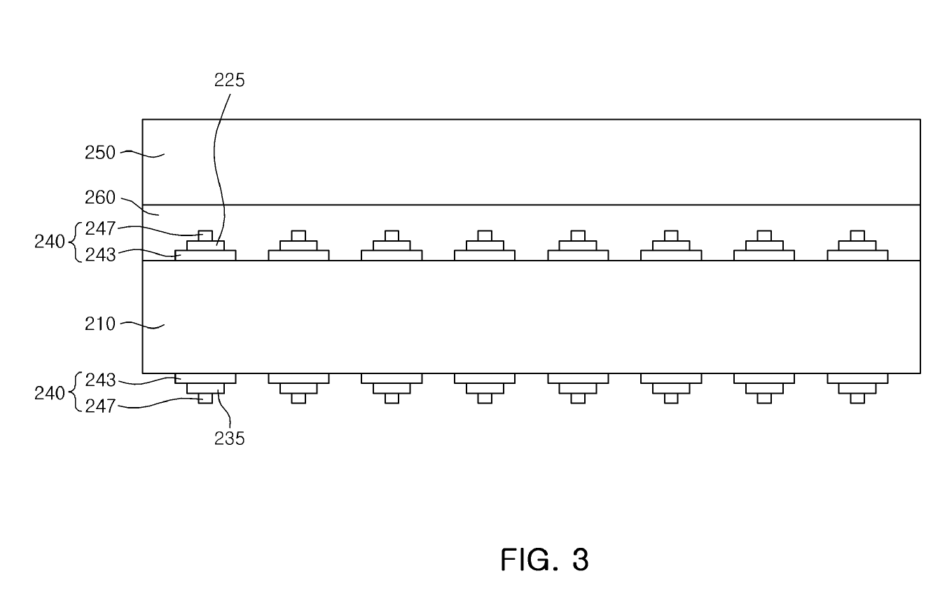

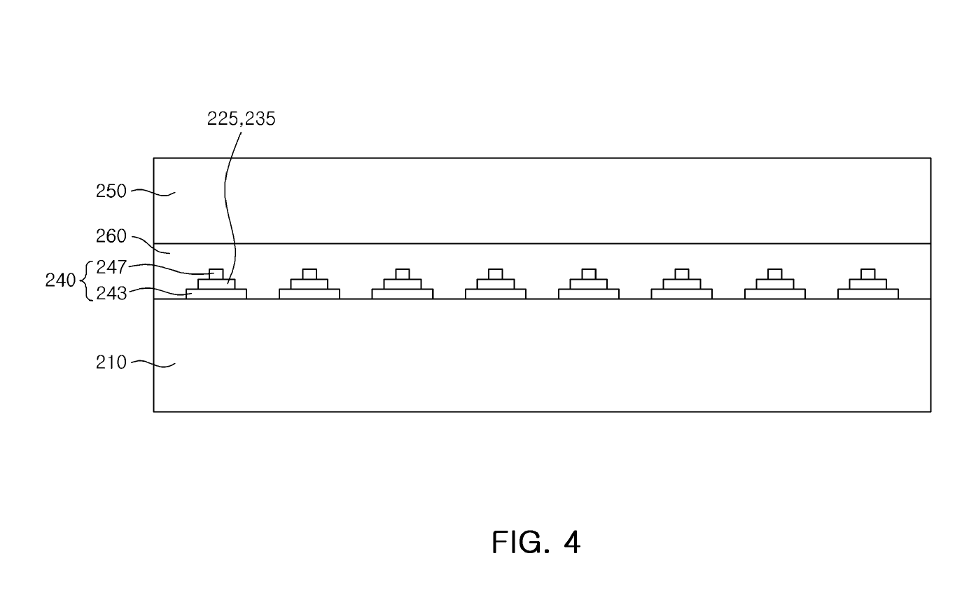

FIG. 2 is a front view of the touch panel according to an exemplary embodiment of the present disclosure. FIGS. 3 and 4 are cross-sectional views of the touch panel according to various exemplary embodiments of the present disclosure.

Referring to FIGS. 2 through 4, a touch panel 200 according to the present exemplary embodiment may include a substrate 210, a plurality of electrodes 220 and 230 provided on the substrate 210, a black treated part 240 formed to decrease visibility of the plurality of electrodes 220 and 230, and a cover window 250 attached to the substrate 210. In this case, an adhesive layer 260 adhering the substrate 210 and the cover window 250 to each other may be an optical clear adhesive (OCA), but is not limited thereto.

Although not shown in FIGS. 2 through 4, each of the plurality of electrodes 220 and 230 may be electrically connected to a flexible circuit substrate attached to one end of the substrate 210 by wirings and bonding pads. A controller integrated circuit may be mounted on the flexible circuit substrate to detect sensing signals generated in the plurality of electrodes 220 and 230 and to determine touch inputs from the detected sensing signals.

The substrate 210 may be a transparent substrate for forming the plurality of electrodes 220 and 230. Therefore, as described above, the substrate 210 may be formed of the film such as polyethylene terephtalate (PET), polycarbonate (PC), polyethersulfone (PES), polyimide (PI), polymethlymethacrylate (PMMA), cyclo-olefin polymers (COP), or the like, and the material such as soda glass or tempered glass.

The plurality of electrodes 220 and 230 may include the first electrodes 220 extending in an X-axis direction and the second electrodes 230 extending in a Y-axis direction. The first electrodes 220 and the second electrodes 230 may be provided on both surfaces of the substrate 210 (see FIG. 3) or provided on one surface of the substrate 210 (see FIG. 4). In this case, when the first electrodes 220 and the second electrodes 230 are provided on one surface of the substrate 210, predetermined insulating layers may be partially formed in intersections between the first electrodes 220 and the second electrodes 230. In addition, unlike those described above, the first electrodes 220 and the second electrodes 230 may be provided on different substrates 210 and intersect with each other.

The apparatus electrically connected to the plurality of electrodes 220 and 230 to sense a touch input may detect changes in capacitance generated in the plurality of electrodes 220 and 230 according to a touch input applied thereto and sense the touch input therefrom. The first electrode 220 may be connected to channels D1 to D8 in the controller integrated circuit to thereby have a predetermined driving signal applied thereto, and the second electrodes 230 may be connected to channels S1 to S8 to thereby be used for detecting the changes in capacitance formed between the first electrodes 220 and the second electrodes 230. In this case, the controller integrated circuit may use the changes in capacitance as the sensing signals to determine the touch input.

The plurality of fine conductive lines 225 and 235 forming each of the plurality of electrodes 220 and 230 may be formed in a net or a mesh pattern. In the case in which the fine conductive lines are formed in the net or the mesh pattern, a phenomenon in which a patterning mark is seen in a region in which an indium-tin oxide (ITO) electrode is present may be decreased and transparency of the touch panel may be improved.

Although FIG. 2 shows a case in which the fine conductive lines 225 and 235 of the plurality of electrodes 220 and 230 are formed in a rhomboid or rectangular pattern, the pattern of the fine conductive lines is not limited thereto, and the pattern of the fine conductive lines according to the present disclosure may include a range apparent to or easily deductable by those skilled in the art such as a hexagonal pattern, an octagonal pattern, a diamond pattern, a random pattern, and the like.

The fine conductive lines 225 and 235 may be formed of one of Ag, Al, Cr, Ni, Mo, and Cu, or an alloy thereof . However, there is a case in which the plurality of electrodes 220 and 230 are recognized by a user due to an intrinsic color of a metal or light reflection.

In the touch panel according to the present exemplary embodiment, the black treated part 240 is formed on the fine conductive lines 225 and 235, such that invisibility of the fine conductive lines may be increased and visibility of the touch panel may be decreased.

Referring to FIGS. 3 and 4, the black treated part 240 may include a first black layer 243 and a second black layer 247. The first black layer 243 may be formed on one surface of the fine conductive lines 225 and 235, facing the substrate 210, and the second black layer 247 may be formed on the other surface of the fine conductive lines 225 and 235 opposite to the one surface of the fine conductive lines 225 and 235.

The first black layer 243 may be disposed between the substrate 210 and the fine conductive lines 225 and 235, and in this case, the first black layer 243 may have a width wider than a line width of the fine conductive lines 225 and 235. The first black layer 243 has the width wider than the line width of the fine conductive lines 225 and 235, such that in the case in which a user views the touch panel from the side of the cover window 250, the plurality of fine conductive lines 235 forming the second electrodes 230 maybe prevented from being recognized by the user.

The second black layer 247 may be formed on an upper surface of each of the fine conductive lines 225 and 235, and the second black layer 247 may have a width narrower than the line width of the fine conductive lines 225 and 235. According to an exemplary embodiment of the present disclosure, the width of the second black layer 247 may correspond to ⅓ of the line width of the fine conductive lines. The second black layer 247 may have the width narrower than the line width of the fine conductive lines 225 and 235, such that the line width of the fine conductive lines 225 and 235 may be recognized to be smaller than an original line width when the user views the touch panel from the side of the cover window 250, thereby preventing the plurality of fine conductive lines 225 and 235 from being recognized by the user.

Specifically, in FIG. 3, the recognition of the fine conductive line 225 forming the first electrode 220 by the user may be prevented, and in FIG. 4, the recognition of the fine conductive line 225 forming the first electrode 220 and the fine conductive line 235 forming the second electrode 230 by the user may be prevented.

Processes for manufacturing the touch panel of FIGS. 3 and 4 will be described as follows. A metal layer for forming the first black layer 243, a metal layer for forming the plurality of fine conductive lines 225 and 235, and a metal layer for forming the second black layer 247 are sequentially stacked on one surface or both surfaces of the substrate 210, and a photo-resist is then coated on the metal layer for forming the second black layer 247.

Thereafter, a predetermined region of the photo-resist is exposed and developed to thereby form a mask pattern, and the metal layer for forming the first black layer 243, the metal layer for forming the plurality of fine conductive lines 225 and 235, and the metal layer for forming the second black layer 247 are simultaneously etched along the mask pattern to thereby form the first black layer 243, the fine conductive lines 225 and 235, and the second black layer 247 in such a manner that the line width thereof is increased in which they are stacked on the substrate.

Finally, one surface of the substrate 210 is adhered to the cover window 250 by the adhesive layer 260.

In this case, the metal layer for forming the first black layer 243, the metal layer for forming the plurality of fine conductive lines 225 and 235, and the metal layer for forming the second black layer 247 may be formed of materials having different etching rates, wherein the etching rate may be increased in the order of stacking metal materials forming the first black layer 243, the plurality of fine conductive lines 225 and 235, and the second black layer 247, respectively.

That is, the metal layer which is firstly stacked on the substrate 210 may have the lowest etching rate, and the metal layer which is lastly stacked on the substrate 210 may have the highest etching rate. The metal layers having different etching rates are sequentially stacked and are then simultaneously etched with a single etchant, such that a manufacturing process may be simplified.

According to the present exemplary embodiment, the metal materials forming the first metal layer 243 and the second metal layer 247 may have complementary colors to each other. Since the metal materials forming the first metal layer 243 and the second metal layer 247 have complementary colors to each other, in the case in which the user views the touch panel, the color of the first metal layer 243 and the color of the second metal layer 247 are mixed to thereby form an achromatic color, such that the plurality of fine conductive lines 225 and 235 may be prevented from being recognized by the user.

As set forth above, according to exemplary embodiments of the present disclosure, visibility of the touch panel may be improved by forming at least one black layer having a width different from a line width of a fine conductive line on an upper surface and a lower surface of the fine conductive line.

Visibility of the fine conductive lines may be improved by forming the black layer on the plurality of fine conductive lines forming the electrode of the touch panel.

While exemplary embodiments have been shown and described above, it will be apparent to those skilled in the art that modifications and variations could be made without departing from the spirit and scope of the present disclosure as defined by the appended claims.

What is claimed is:

1. A touch panel, comprising:
a substrate;
a plurality of fine conductive lines provided on one surface of the substrate; and
a black treated part including a first black layer and a second black layer provided on the one surface of the substrate,
wherein the first black layer, the plurality of fine conductive lines, and the second black layer are sequentially stacked on the substrate, the first black layer has a width wider than a line width of the fine conductive lines, and the second black layer has a width narrower than the line width of the fine conductive lines.

2. The touch panel of claim 1, wherein the fine conductive lines have an etching rate higher than that of the first black layer and lower than that of the second black layer.

3. The touch panel of claim 1, wherein the width of the second black layer corresponds to ⅓ of the line width of the fine conductive lines.

4. The touch panel of claim 1, wherein the first black layer and the second black layer have complementary colors to each other.

5. The touch panel of claim 1, wherein the plurality of fine conductive lines are formed of one of Ag, Al, Cr, Ni, Mo, and Cu, or an alloy of at least two of Ag, Al, Cr, Ni, Mo, and Cu.

6. The touch panel of claim 1, further comprising: a cover window adhered to the one surface of the substrate.

7. A manufacturing method of a touch panel, the manufacturing method comprising:
stacking three metal layers on one surface of a substrate; and
forming an electrode pattern by etching the three metal layers using a single etchant,
wherein the three metal layers have an etching rate that increases as a height of the stacked metal layers are increased.

8. The manufacturing method of claim 7, wherein the forming of the electrode pattern includes:
coating a photo-resist on a highest layer of the three metal layers;
forming a predetermined mask pattern by exposing and developing the photo-resist; and
forming a first black layer, fine conductive lines, and a second black layer, sequentially stacked on the substrate, by etching the three metal layers along the mask pattern.

9. The manufacturing method of claim 8, wherein the first black layer has a width wider than a line width of the fine conductive lines, and the second black layer has a width narrower than the line width of the fine conductive lines.

10. The manufacturing method of claim 9, wherein the width of the second black layer corresponds to ⅓ of the line width of the fine conductive lines.

11. The manufacturing method of claim 7, wherein a metal material of a highest metal layer and a metal material of a lowest metal layer, among the three metal layers, have complementary colors to each other.

12. The manufacturing method of claim 7, further comprising: bonding a cover window to the one surface of the substrate by a predetermined adhesive layer.

13. The manufacturing method of claim 7, wherein an intermediate layer of the three metal layers is formed of one of Ag, Al, Cr, Ni, Mo, and Cu, or an alloy of at least two of Ag, Al, Cr, Ni, Mo, and Cu.

14. A touch panel comprising:
a substrate;
a plurality of fine conductive lines provided on one surface of the substrate; and
a black treated part including a first black layer formed on one surface of the fine conductive lines, facing the substrate, and a second black layer formed on the other surface of the fine conductive lines, opposite to one surface of the fine conductive lines;
wherein the first black layer has a width wider than a line width of the fine conductive lines, and the second black layer has a width narrower than the line width of the fine conductive lines.
